(19) United States
(12) Patent Application Publication
(10) Pub. No.: US 2006/0283904 A1
(43) Pub. Date: Dec. 21, 2006

(54) STROLLER ATTACHMENT DEVICE

(75) Inventor: Katie Lynn Dinslage, Farmington, MN (US)

Correspondence Address: OPPENHEIMER WOLFF & DONNELLY LLP, 45 SOUTH SEVENTH STREET, SUITE 3300, MINNEAPOLIS, MN, 55402, US

(73) Assignee: CARRY YOU LLC, Farmington, MN (US)

(21) Appl. No.: 11/421,291

(22) Filed: May 31, 2006

Related U.S. Application Data
(60) Provisional application No. 60/686,328, filed on Jun. 1, 2005.

(51) Int. Cl. B60R 7/00

(52) U.S. Cl. 224/409

(57) ABSTRACT

A stroller attachment device is provided. The stroller attachment device includes at least one anchor panel having first and second container holders with at least three pockets therebetween. The at least one anchor panel also has left and right attachment mechanisms. The first and second container holders are configured to secure full-size beverage containers therewithin. The stroller attachment device can be optionally equipped with fourth, fifth or mesh pockets. All of the pockets can include pocket top enclosures for securing personal property therewithin.

### CROSS REFERENCE TO RELATED APPLICATION

This application is based on and claims the benefit of U.S. Provisional Application No. 60/686,328, filed Jun. 1, 2005, the entirety of which is hereby incorporated by reference.

### BACKGROUND OF THE INVENTION

The present invention relates to a stroller attachment device. Specifically, this invention relates to a stroller attachment device providing support for cups, bottles and the like.

While pushing their children in strollers, parents and caregivers often find themselves without the ability to carry their personal items, such as beverages, money, credit cards, identification cards, keys and the like. Several existing strollers are not equipped with a stroller attachment device that can be used for these purposes. There exists a need for a stroller attachment device that can be easily attached to and detached from various strollers.

Much of the existing technology pertaining to stroller storage relates to storage of infant and child items, such as bottles, diapers, toys, etc. In fact, existing stroller attachment devices are generally designed with smaller cup holders to accommodate bottles and larger pockets areas to accommodate infant and toddler toys and gear. There exists a need for a stroller attachment device that provides sufficiently large container holders to accommodate various sizes of adult beverage containers as well as infant, toddler and child food and beverage containers. There also exists a need for a stroller attachment device having smaller, closed pockets where parents and care givers can store valuable personal items, such as money, credit cards, identification cards, keys and the like. There also exists a need for a stroller attachment device that is compatible with a variety of different strollers.

### SUMMARY OF THE INVENTION

The present invention addresses the above-mentioned needs by providing a stroller attachment device with container holders and various sized pockets that can be easily attached to and detached from various strollers. The stroller attachment device in accordance with the present invention includes an anchor panel; first and second container holders attached to the anchor panel, with at least three pockets positioned between the first and second container holders, where the first and second container holders are configured to secure beverage containers therewithin; a left attachment means operably attached to one top corner of the anchor panel and configured to attach the stroller attachment to a stroller support; and a right attachment means operably attached to a second top corner of the anchor panel and configured to attach the stroller attachment device to the stroller support.

Another aspect of the present invention provides a stroller attachment device including at least one anchor panel; first and second container holders attached to the anchor panel and having first, second and third pockets therebetween, where the first and second container holders are configured to secure beverage containers therewithin; a left attachment means operably attached to one top corner of the anchor panel and configured to accommodate attachment to a stroller; and a right attachment means operably attached to a second top corner of the anchor panel and configured to accommodate attachment to the stroller, where the first pocket is about 6 inches to about 9 inches high, and wherein the second pocket is about 4 inches high to about 5 inches high, and where the third pocket is about 2.5 inches high to about 3.5 inches high.

The invention will be further described with reference to the following detailed description taken in conjunction with the drawings.

### BRIEF DESCRIPTION OF THE DRAWINGS

FIG. 1 is a front view of a stroller attachment device.

FIG. 2 is a side perspective view of the stroller attachment device connected to a stroller.

### DETAILED DESCRIPTION OF THE INVENTION

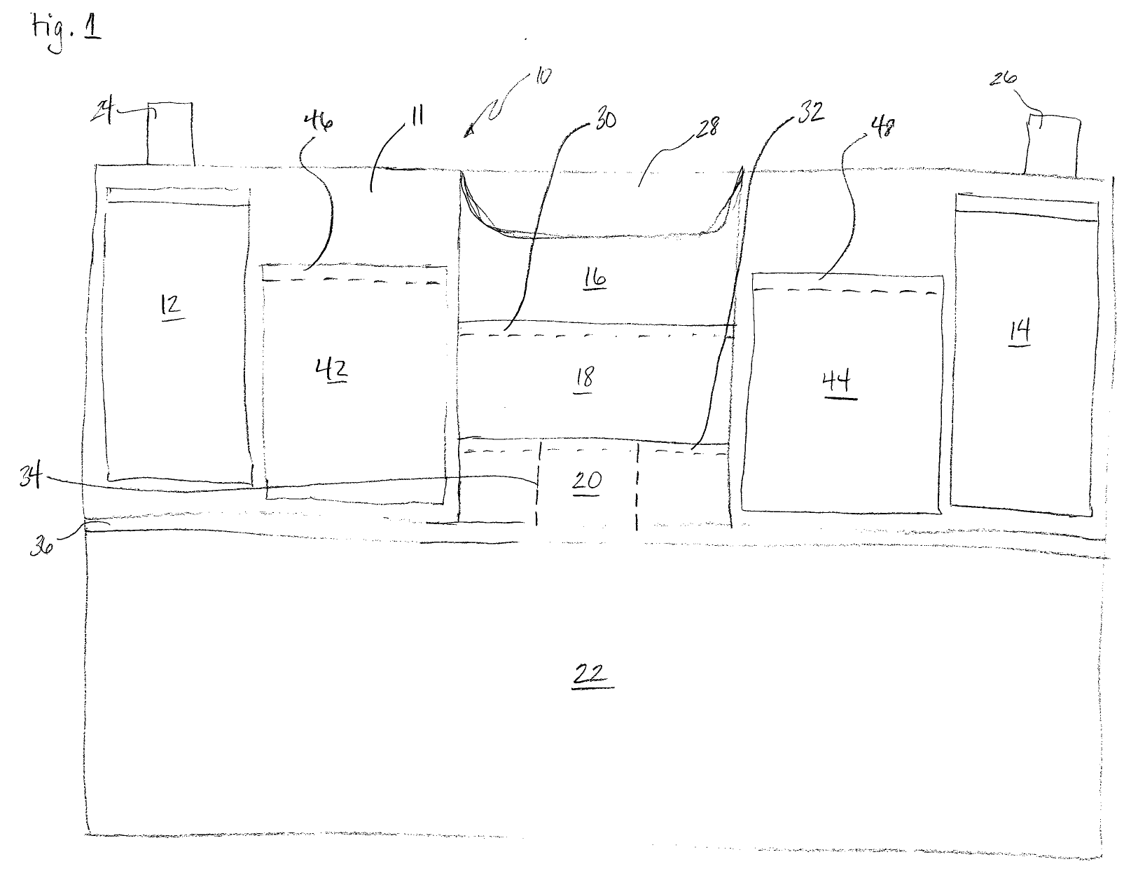

Referring now to FIG. 1 there is shown a stroller attachment device 10 having at least one anchor panel 11 on which can be secured a first container holder 12, a second container holder 14, a first pocket 16, a second pocket 18, a third pocket 20, a fourth pocket 42, a fifth pocket 44, a mesh pouch 22, a left attachment mechanism 24 and a right attachment mechanism 26. Stroller attachment device 10 is generally constructed of woven nylon pack material.

Referring still to FIG. 1, first and second container holders 12, 14 are sized to hold and support a wide variety of different shaped cups, bottles, glasses and other drinking containers. In one embodiment, first and second container holders 12, 14 range in size from about 3 inches wide by to about 4 inches wide, about 3 inches deep to about 4 inches deep, and about 4 inches high to about 5 inches high with an open, semi-enclosed or fully enclosed bottom section. The semi-enclosed or enclosed bottom sections are constructed of woven nylon pack or other nylon type fabrics and configured to maintain a beverage container within the first and second container holders 12, 14. In another embodiment, first and second container holders 12, 14 are about 3.25 inches wide, 3.25 inches deep and about 4.5 inches high with fully enclosed bottoms.

Again referring to FIG. 1, first, second and third pockets 16, 18, 20 are generally the same width and are horizontally positioned between first container holder 12 and second container holder 14. In one embodiment, first, second and third pockets 16, 18, 20 are about 6 inches to about 9 inches wide. In another embodiment, first, second and third pockets 16, 18, 20 are approximately 8.5 inches wide. In yet another embodiment, first, second and third pockets 16, 18, 20 are approximately 6 inches wide.

The height of first pocket 16 is slight larger than second and third pockets 18, 20 with a height ranging from about 6 inches to about 9 inches. In one embodiment, the height of first pocket 16 is approximately 8.5 inches. In another embodiment, the height of first pocket 16 is approximately 6 inches. First pocket 16 can be positioned behind second and third pockets 18, 20 such that second and third pockets 18, 20 are attached to an outer side of first pocket 16.

In one embodiment, first pocket 16 has a first pocket top enclosure 28. First top pocket top enclosure 28 can be a flap type enclosure having a piece of material that hangs over the opening of first pocket 16 such that a user must lift up first pocket top enclosure 28 to access the area inside first pocket 16. This sort of flap type enclosure can have an optional fastening mechanism to secure it to the outer side of first pocket 16. In another embodiment, first pocket top enclosure 28 has a fastening mechanism extending horizontally along the top of first pocket 16. This type of fastening mechanism is selected from the group including, but not limited to, zippers, Velcro, snaps, buttons, hook and eye fasteners and the like.

Second pocket 18 ranges in height from about 4 inches to about 7 inches. In one embodiment, second pocket 18 is approximately 5.25 inches high. In another embodiment, second pocket 18 is approximately 6 inches high. Second pocket 18 also has an optional second pocket top enclosure 30. Second pocket top enclosure 30 has a fastening mechanism extending horizontally along the top of second pocket 18. This type of fastening mechanism is selected from the group including, but not limited to, zippers, Velcro, snaps, buttons, hook and eye fasteners and the like.

Third pocket 20 ranges in height from about 2.5 inches to about 4.5 inches. In one embodiment, third pocket 20 is approximately 3.5 inches high. In another embodiment, third pocket 20 is approximately 4 inches high. In yet another alternate embodiment, third pocket 20 is omitted from stroller attachment device 10. Third pocket 20 has an optional third pocket top enclosure 32. Third pocket top enclosure 32 has a fastening mechanism extending horizontally along the top of third pocket 20. This type of fastening mechanism is selected from the group including, but not limited to, zippers, Velcro, snaps, buttons, hook and eye fasteners and the like. In one embodiment, third pocket 20 has vertically extending separations 34 providing special storage for cards, including business cards, credit cards, driver's licenses, and the like.

Fourth pocket 42 ranges in width from about 5 inches to about 7 inches. Fourth pocket 42 ranges in height from about 4 inches to about 8 inches. In one embodiment, fourth pocket 42 is approximately 6 inches wide and approximately 5.25 inches high. In one embodiment, fourth pocket 42 is optional and can be omitted from stroller attachment device 10. In another embodiment, fourth pocket 42 is the same height as stroller attachment device 10. Fourth pocket 42 has an optional fourth pocket top enclosure 46. Fourth pocket top enclosure 46 has a fastening mechanism extending horizontally along the top of fourth pocket 42. This type of fastening mechanism is selected from the group including, but not limited to, zippers, Velcro, snaps, buttons, hook and eye fasteners, and the like.

Fifth pocket 44 ranges in width from about 5 inches to about 7 inches. Fifth pocket 44 ranges in height from about 4 inches to about 8 inches. In one embodiment, fifth pocket 44 is approximately 6 inches wide and approximately 5.25 inches high. In one embodiment, fifth pocket 44 is optional. In another embodiment, fifth pocket 44 is the same height as stroller attachment device 10. Fifth pocket 44 has an optional fifth pocket top enclosure 48. Fifth pocket top enclosure 48 has a fastening mechanism extending horizontally along the top of fifth pocket 48. This type of fastening mechanism is selected from the group including, but not limited to, zippers, Velcro, snaps, buttons, hook and eye fasteners and the like.

Referring again to FIG. 1, mesh pocket 22 of stroller attachment device 10 is generally positioned vertically beneath first and second container holders 12, 14 and first through fifth pockets 16, 18, 20, 42, 44. Mesh pocket 22 ranges in size from about 15 inches wide to about 19 inches wide and about 7.5 inches high to about 9.5 inches high. In one embodiment, mesh pocket is approximately 17 inches wide by about 8.5 inches high. In another embodiment, mesh pocket 22 is optional. Mesh pocket 22 is generally constructed of a woven mesh material such that items within mesh pocket 22 are visible through the woven mesh material. Mesh pocket 22 has an optional mesh pocket top enclosure 36. Mesh pocket top enclosure 36 has a fastening mechanism extending horizontally along the top of mesh pocket 22. This type of fastening mechanism is selected from the group including, but not limited to, zippers, Velcro, snaps, buttons, hook and eye fasteners, and the like.

Left attachment mechanism 24 is generally positioned above first container holder 12. Right attachment mechanism 26 is generally positioned above second container holder 14. Left and right attachment mechanisms 24, 26 are constructed of a sturdy material having some sort of fastening mechanism. In one embodiment, left and right attachment mechanisms 24, 26 are constructed of ribbon material having a snap, hook and eye, button or other type of fastening means. In another embodiment, left and right attachment mechanisms 24, 26 are constructed of ribbon material covered a fastening type fabric, such as Velcro. In summary, any convenient mechanism can be used, which securely attaches stroller attachment device 10 to a stroller.

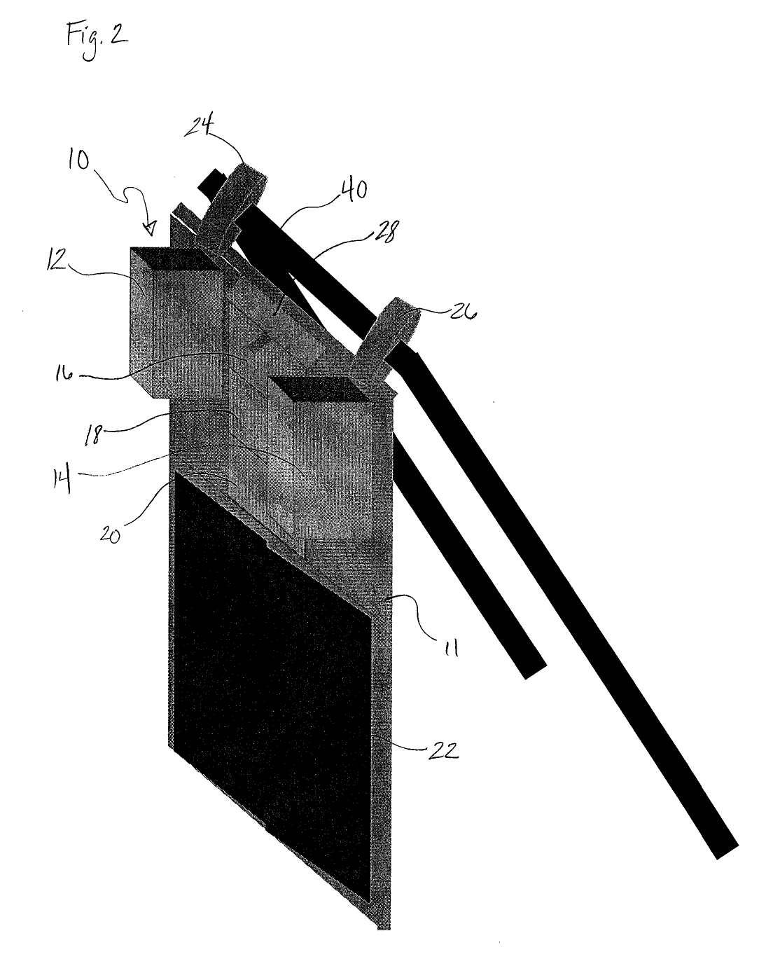

Referring now to FIG. 2, there is shown a side perspective view of stroller attachment 10 of the present invention as it is mounted over a stroller support 40 and hangs via gravity from left and right attachment mechanisms 24, 26.

Now that each component of the present invention has been discussed, following is a discussion of a method of use of stroller attachment device 10 in accordance with the present invention. Referring again to FIG. 2, a user positions stroller attachment device 10 such that the back of stroller attachment device 10 faces stroller support 40 with left and right attachment mechanisms positioned at the top of stroller support 40. The user then encircles stroller support 40 with left and right attachment mechanisms 24, 26 and fastens fastening means on left and right attachment mechanisms 24, 26. In this manner, stroller attachment device 10 is securely attached to stroller support 40 and hangs via gravity from left and right attachment mechanism 24, 26. In one embodiment, stroller support 40 is a stroller handle bar. In another embodiment, stroller support 40 may be any attachment point on the stroller, including independent handles, stroller support bars, and other hardware attached to the stroller (i.e., clips, hooks, and the like).

Once stroller attachment device 10 is secured to stroller support 40, a user may place food and beverage containers, pacifiers, personal items, and the like in first and second container holders 12, 14. The user may also place sippy cups, pacifiers, personal items, and the like in first, second, third, fourth and fifth pockets 16, 18, 20, 42, 44. In addition, mesh pocket 22 may be used to store personal items for the user or for an infant or child being pushed in the stroller. Since mesh pocket top enclosure 36 extends horizontally along the top of mesh pocket 22, users can access items stored in mesh pocket 22 quickly and efficiently.

The invention has herein been described in its preferred embodiments to provide those skilled in the art with the information needed to apply the novel principles and to construct and use the embodiments. However, it is to be understood that the invention can be carried out by specifically different devices and that various modifications can be accomplished without departing from the scope of the invention itself.

What is claimed is:

1. A stroller attachment device comprising:
at least one anchor panel;
first and second container holders attached to the anchor panel and having at least three pockets therebetween, wherein the first and second container holders are configured to secure beverage containers therewithin;
a left attachment means operably attached to one top corner of the anchor panel and configured to accommodate attachment to a stroller; and
a right attachment means operably attached to a second top corner of the anchor panel and configured to accommodate attachment to the stroller.

2. The stroller attachment device of claim 1 further comprising a fourth pocket and a fifth between the first and second container holders.

3. The stroller attachment device of claim 1 further comprising a mesh pocket operably attached to a bottom of the anchor panel.

4. The stroller attachment device of claim 1 wherein the first and second container holders are about 3 inches wide to about 4 inches wide, about 3 inches deep to about 4 inches deep and about 4 inches high to about 5 inches high.

5. The stroller attachment device of claim 1 wherein the first and second container holders are about 3.25 inches wide, about 3.25 inches deep and about 4.5 inches high.

6. The stroller attachment device of claim 1 wherein the first and second container holders comprise a semi-enclosed bottom.

7. The stroller attachment device of claim 1 wherein the first and second container holders comprise a fully enclosed bottom.

8. The stroller attachment device of claims 2 wherein the pockets have a pocket top enclosure.

9. The stroller attachment device of claim 9 wherein the pocket top enclosure comprise a fastening means selected from the group consisting of zippers, Velcro, snaps, buttons, and hook and eye fasteners.

10. The stroller attachment device of claim 1 wherein the first and second attachment means comprise fastening mechanisms selected from the group consisting essentially of snaps, buttons, hook and eye fasteners and Velcro.

11. A stroller attachment device comprising:
at least one anchor panel;
first and second container holders attached to the anchor panel and having first, second and third pockets therebetween, wherein the first and second container holders are configured to secure beverage containers therewithin;
a left attachment means operably attached to one top corner of the anchor panel and configured to accommodate attachment to a stroller; and
a right attachment means operably attached to a second top corner of the anchor panel and configured to accommodate attachment to the stroller,
wherein the first pocket is about 6 inches to about 9 inches high,
and further wherein the second pocket is about 4 inches high to about 7 inches high,
and further wherein the third pocket is about 2.5 inches high to about 4.5 inches high.

12. The stroller attachment device of claim 11 further comprising a fourth pocket and a fifth between the first and second container holders.

13. The stroller attachment device of claim 11 further comprising a mesh pocket operably attached to a bottom of the anchor panel.

14. The stroller attachment device of claim 11 wherein the first and second container holders comprise a semi-enclosed bottom.

15. The stroller attachment device of claim 11 wherein the first and second container holders comprise a fully enclosed bottom.

16. The stroller attachment device of claims 12 wherein the pockets have a pocket top enclosure.

17. The stroller attachment device of claim 16 wherein the pocket top enclosure comprise a fastening means selected from the group consisting of zippers, Velcro, snaps, buttons, and hook and eye fasteners.

18. A means for mounting a stroller attachment device on a stroller support comprising:
at least one anchoring means for holding first and second container holders with at least three pockets therebetween and first and second attachment mechanisms thereon, wherein first and second container holders are configured to secure beverage containers therewithin;
a means for securing the first attachment mechanism to the stroller support; and
a means for securing the second attachment mechanism to the stroller support.

19. The stroller attachment device of claim 18 further comprising a fourth pocket and a fifth between the first and second container holders.

20. The stroller attachment device of claim 18 further comprising a mesh pocket operably attached to a bottom of the anchor panel.
